(19) United States
(12) Patent Application Publication
(10) Pub. No.: US 2013/0000803 A1
(43) Pub. Date: Jan. 3, 2013

(54) Tire the Crown of Which has a Stiffening Reinforcement

(75) Inventor: Sébastien Fugier, Greer, SC (US)

(73) Assignees: Michelin Recherche et Technique S.A., Granges-Paccot (CH); COMPAGNIE GENERALE DES ETABLISSEMENTS MICHELIN, Clermont-Ferrand (FR)

(21) Appl. No.: 13/516,177

(22) PCT Filed: Nov. 29, 2010
(86) PCT No.: PCT/EP2010/068426

§ 371 Date: Aug. 14, 2012

Related U.S. Application Data
(60) Provisional application No. 61/312,585, filed on Mar. 10, 2010.

(30) Foreign Application Priority Data
Dec. 14, 2009 (FR) 0958929

(51) Int. Cl. B60C 9/18; B60C 15/00; B60C 9/02; B60C 11/117

(52) U.S. Cl. 152/209.1

(57) ABSTRACT

Tire (10) comprising a tread (40) divided, by the median plane (130) of the tire, into a first semi-tread (41) which extends axially from said median plane toward a first axial edge (45) of the tread, the first semi-tread comprising a first main circumferential groove (141) opening onto the rolling surface, and a second semi-tread (42) which extends axially from said median plane toward a second axial edge (46) of the tread, the tire further comprising an additional stiffening reinforcement (151) comprising a plurality of substantially radially directed thread-like reinforcing elements, this additional stiffening reinforcement being situated radially on the inside of the carcass reinforcement and in direct radial alignment with said first main circumferential groove, the additional stiffening reinforcement (151) extending axially on each side of the first main circumferential groove (141) over an axial distance less than or equal to 75% of the axial distance separating the first main circumferential groove (141) from any other circumferential groove of the tread or, as appropriate, from the axial edges (45, 46) of the tread.

### RELATED APPLICATIONS

This is a U.S. national stage of application No. PCT/EP2010/068426, filed on Nov. 29, 2010. Priority is claimed on the following applications: French Application No. 0958929 filed on Dec. 14, 2009 and U.S. Application No. 61/312,585 filed on Mar. 10, 2010, the contents of both of which are hereby incorporated by reference.

### FIELD OF THE INVENTION

The present invention relates to tires for passenger vehicles. It relates more particularly to tires suited to sporty driving.

### BACKGROUND

Under sporty driving conditions, tires experience significant transverse loads, particularly when the vehicle fitted with the tires enters a bend. These transverse loads cause the contact area where each tire makes contact with the ground on which it is driving to become trapezoidal, i.e. that side of the contact area that lies on the side of the vehicle that is on the outside (with respect to the center) of the bend lengthens, whereas that side of the contact area which lies closer to the center of the bend shortens. As a result, the various ribs on the tread sustain different loads. It is the most heavily loaded ribs which bear the greater proportion of the transverse load. They, therefore, have a tendency to tilt and this has the effect of reducing the contact surface between the rib and the ground.

The combination of (i) the loss of area of the ribs that lie on the outside of the tire with respect to the center of the bend and of (ii) the increase in the load borne by these ribs results in the tread being damaged. For example, uneven wear of the edges of the ribs and loss of rubber compound can be observed.

One solution to this problem has been proposed in document EP 1 726 458 wherein an additional stiffening reinforcement extending axially over practically the entire width of the tread is provided. While this solution does reduce the phenomena of uneven wear, it has the effect of increasing the mass of the tire and of deteriorating user comfort.

### SUMMARY OF THE INVENTION

One of the objectives of the present invention is to reduce the uneven wear of the tread of tires designed for sporty driving and to improve their endurance while at the same time reducing to the absolute minimum the weight added to the tire and the stiffening of the crown.

This objective is achieved through at least one narrow stiffening reinforcement astutely positioned under the crown of the tire.

More specifically, the objective is achieved using a tire configured to be mounted on a mounting rim of a wheel of a vehicle, comprising:

two beads configured to come into contact with the mounting rim, each bead comprising at least one annular reinforcing structure;

two sidewalls extending the beads radially outward, the two sidewalls meeting in a crown comprising a crown reinforcement surmounted by a tread comprising a rolling surface;

at least one carcass reinforcement extending from the beads through the sidewalls as far as the crown, the carcass reinforcement being anchored in the two beads;

wherein the tread is divided, by the median plane of the tire, into:

a first semi-tread which extends axially from said median plane toward a first axial edge of the tread, the first semi-tread comprising a first main circumferential groove opening onto the rolling surface, and

a second semi-tread which extends axially from said median plane toward a second axial edge of the tread.

The tire further comprises an additional stiffening reinforcement comprising a plurality of substantially radially directed thread-like reinforcing elements, that is to say thread-like reinforcing elements that make an angle greater than or equal to 60° (and preferably 80°) and less than or equal to 90° with the circumferential direction, this additional stiffening reinforcement being situated radially on the inside of the carcass reinforcement and in direct radial alignment with said first main circumferential groove.

The additional stiffening reinforcement extends axially on the outside of the axially outermost point of said first main circumferential groove, such that, in any radial cross section, the axial distance DEE1 between the axially outermost point of the additional stiffening reinforcement and the axially outermost point of said first main circumferential groove is less than or equal to 75% of an axial distance DAE1, this axial distance DAE1 being defined:

either, if there is no circumferential groove opening onto the rolling surface axially between said first main circumferential groove and said first axial edge of the tread, as the axial distance between the axially outermost point of said first main circumferential groove and said first axial edge of the tread,

or, if there is an additional circumferential groove opening onto the rolling surface axially between said first main circumferential groove and said first axial edge of the tread, as the axial distance between the axially outermost point of said first main circumferential groove and the axially innermost point of said additional circumferential groove.

Moreover, the additional stiffening reinforcement extends axially on the inside of the axially innermost point of said first main circumferential groove, such that, in any radial cross section, the axial distance DEI1 between the axially innermost point of the additional stiffening reinforcement and the axially innermost point of said first main circumferential groove is less than or equal to 75% of an axial distance DAI1, this axial distance DAI1 being defined:

either, if there is no circumferential groove opening onto the rolling surface axially between said first main circumferential groove and said second axial edge of the tread, as the axial distance between the axially innermost point of said first main circumferential groove and said second axial edge of the tread,

or, if there is an additional circumferential groove opening onto the rolling surface axially between said first main circumferential groove and said second axial edge of the tread, as the axial distance between the axially innermost point of said first main circumferential groove and that point of said additional circumferential groove that is axially closest to said first main circumferential groove.

Providing such an additional stiffening reinforcement astutely modifies the local flexural rigidity of the tread of the tire and makes it possible to limit tread deformation in regions which have a tendency to lose contact with the ground. The increase in the local loading is therefore reduced, and so is the tread degradation.

According to one advantageous embodiment, the carcass reinforcement comprises a plurality of carcass reinforcing elements and the carcass reinforcing elements are textile.

The thread-like reinforcing elements of the additional stiffening reinforcement are preferably textile, but could equally be made of metal. Preferably, the thread-like reinforcing elements of the additional stiffening reinforcement have an extension modulus greater than or equal to 1 GPa and the additional stiffening reinforcement has a reinforcing element density greater than or equal to 100 per dm.

According to an advantageous embodiment, the tread has no additional circumferential groove opening onto the rolling surface axially between said first main circumferential groove and said first axial edge of the tread. Thus, the circumferential groove closest to the first axial edge of the tread which is likely to find itself furthest toward the outside of the tire with respect to the center of the bend is provided with an additional stiffening reinforcement.

According to another advantageous embodiment, when the tread does have an additional circumferential groove opening onto the rolling surface axially between said first main circumferential groove and said first axial edge of the tread, the axial distance DEE1 between the axially outermost point of the additional stiffening reinforcement and the axially outermost point of said first main circumferential groove is less than or equal to 50% of the axial distance between the axially outermost point of said first main circumferential groove and the axially innermost point of said additional circumferential groove. As a matter of fact, when there is an additional circumferential groove being situated axially between the first main circumferential groove and the first axial edge of the tread, it has been found to be advantageous to shorten the additional stiffening reinforcement on the side closer to the additional circumferential groove.

When the tire is an asymmetric tire, as a result of its structure or of the composition of the tread, it has a predetermined direction of mounting. In other words, the tire has a side which has to face the outside of the vehicle when the tire is mounted on the vehicle. In this specific case, it is advantageous that the tire has just one single additional stiffening reinforcement and that the first axial edge of the tread lies on that side of the tire which, when the tire is mounted on the vehicle in said predetermined direction of mounting, faces the outside of the vehicle.

By contrast, when the tire is a tire of the “directional” type, which means that it has a preferred direction of rotation, it is advantageous that the second semi-tread has a second main circumferential groove opening onto the rolling surface, the tire further comprising a second additional stiffening reinforcement comprising a plurality of substantially radially directed thread-like reinforcing elements, this second additional stiffening reinforcement being situated radially on the inside of the carcass reinforcement and in direct radial alignment with said second main circumferential groove.

The second additional stiffening reinforcement extends axially on the outside of the axially outermost point of said second main circumferential groove, such that, in any radial cross section, the axial distance DEE2 between the axially outermost point of the second additional stiffening reinforcement and the axially outermost point of said second main circumferential groove is less than or equal to 75% of the axial distance DAE2, this axial distance DAE2 being defined:

either, if there is no circumferential groove axially between said second main circumferential groove and said second axial edge of the tread, as the axial distance between the axially outermost point of said second main circumferential groove and said second axial edge of the tread,

or, if there is an additional circumferential groove axially between said second main circumferential groove and said second axial edge of the tread, as the axial distance between the axially outermost point of said second main circumferential groove and the axially innermost point of said additional circumferential groove.

Furthermore, the second additional stiffening reinforcement extends axially on the inside of the axially innermost point of said second main circumferential groove, such that, in any radial cross section, the axial distance DEI2 between the axially innermost point of the second additional stiffening reinforcement and the axially innermost point of said second main circumferential groove is less than or equal to 75% of the axial distance DAI2, this axial distance DAI2 being defined:

either, if there is no circumferential groove axially between said second main circumferential groove and said first main circumferential groove, as the axial distance between the axially innermost point of said second main circumferential groove and the axially innermost point of said first main circumferential groove,

or if there is an additional circumferential groove axially between said second main circumferential groove and said first main circumferential groove, as the axial distance between the axially innermost point of said second main circumferential groove and the point of this additional circumferential groove that is axially closest to said second main circumferential groove.

Providing a second main circumferential groove makes it possible for the tire to be mounted on the vehicle without having to take care as to which side of the tire said first main circumferential groove is situated on. Whichever side of the tire lies on that side of the tire that faces the outside of the vehicle when the tire is mounted on the vehicle in said predetermined direction of mounting, there will be a circumferential groove associated with an additional stiffening reinforcement on the side of the tire that faces the outside of the vehicle.

In a similar way to that which was explained in respect of the first main circumferential groove, it is then preferable to ensure that, when the tread is provided with an additional circumferential groove axially between said second main circumferential groove and said second axial edge of the tread, the axial distance DEE2 between the axially outermost point of the second additional stiffening reinforcement and the axially outermost point of said second main circumferential groove is less than or equal to 50% of the axial distance between the axially outermost point of said second main circumferential groove and the axially innermost point of said additional circumferential groove.

Of course, it is possible, and even desirable, to combine two or more of the embodiments described.

### BRIEF DESCRIPTION OF THE DRAWINGS

FIG. 1 depicts a tire according to the prior art.

FIG. 2 depicts a partial perspective view of a tire according to the prior art.

FIG. 3 depicts, in radial cross section, one quarter of a tire according to the prior art.

FIGS. 4 and 5 illustrate how the axial edge of a tread is determined.

FIGS. 6 to 9 schematically depict the deformation that a tire according to the prior art undergoes when it experiences substantial transverse loading.

FIGS. 10 to 16 depict, in radial cross section, one portion of a tire according to an embodiment of the invention.

FIGS. 17 and 18 show the effect that the width of the additional stiffening reinforcement has on the deflection of a tire.

### DETAILED DESCRIPTION OF THE DRAWINGS

When using the term “radial” it is appropriate to make a distinction between various different uses that the person skilled in the art makes of this word. Firstly, the expression refers to a radius of the tire. It is in that sense that a point P1 is said to be “radially inside” a point P2 (or “radially on the inside of” the point P2) if it is closer to the axis of rotation of the tire than is the point P2. Conversely, a point P3 is said to be “radially outside” a point P4 (or “radially on the outside of” the point P4) if it is further from the axis of rotation of the tire than is the point P4. Progress “radially inward (or outward)” will mean progress toward smaller (or larger) radii. In terms of radial distances, it is this sense of the word that applies also.

A “radial direction” is a direction parallel to a radius of the tire and that intersects the axis of rotation of the tire.

Traditionally, the carcass reinforcement of a tire extends from one bead to the other. In such cases, when the additional stiffening reinforcement is said to lie “radially on the inside of the carcass reinforcement” what that means is that the radial direction passing through any arbitrary point on the additional stiffening reinforcement has an intersection with the carcass reinforcement that is radially on the outside of the additional stiffening reinforcement. In the more rare case of a tire the carcass reinforcement of which is interrupted at the crown region and which therefore comprises two axially separate portions, the additional stiffening reinforcement would be said to lie “radially on the inside of the carcass reinforcement” when, in any radial cross section, it lies radially on the inside of the line passing through the radially outermost point of each of the portions.

By contrast, a thread or a reinforcement is said to be “radial” when the thread or the reinforcing elements of the reinforcement make an angle greater than or equal to 80° and less than or equal to 90° with the circumferential direction. Let us specify that in this particular document, the term “thread” is to be understood in a very general sense of the word and encompasses threads in the form of monofilaments, multifilaments, a cord, a yarn or an equivalent assembly, irrespective of the material of which the thread is made or of the coating applied to it to enhance its bonding with the rubber.

Finally, a “radial cross section” or “radial section” here means a cross section or a section on a plane which contains the axis of rotation of the tire.

An “axial” direction is a direction parallel to the axis of rotation of the tire. A point P5 is said to be “axially inside” a point P6 (or “axially on the inside of” the point P6) if it is closer to the median plane of the tire than is the point P6. Conversely, a point P7 is said to be “axially outside” a point P8 (or “axially on the outside of” the point P8) if it is further from the median plane of the tire than is the point P8. The “median plane” of the tire is the plane which is perpendicular to the axis of rotation of the tire and which lies equal distances from the annular reinforcing structures of each bead.

A “circumferential” direction is a direction perpendicular both to a radius of the tire and to the axial direction. A “circumferential section” is a section on a plane perpendicular to the axis of rotation of the tire.

Two reinforcing elements are said to be “parallel” in this document when the angle formed between the two elements is less than or equal to 20°.

What is meant here by “rolling surface” is all the points on the tread of a tire that come into contact with the ground when the tire is rolling.

The expression “semi-tread” denotes each of the two portions of the tread which lie one on each side of the median plane of the tire. Because the median plane does not necessarily divide the tread into two portions of equal axial width, the term “semi-tread” does not necessarily denote half of the tread.

A circumferential groove is said to be “main” when it is associated with an additional stiffening reinforcement. The term “main” does not therefore mean that such a circumferential groove is wider, deeper, etc. than some other groove, but serves solely to distinguish the grooves that lie in direct radial alignment with an additional stiffening reinforcement.

The expression “rubber compound” denotes a composition of rubber containing at least one elastomer and one filler.

To make the description of the variants shown with the figures easier to read, the same references are used to denote elements that have identical structures.

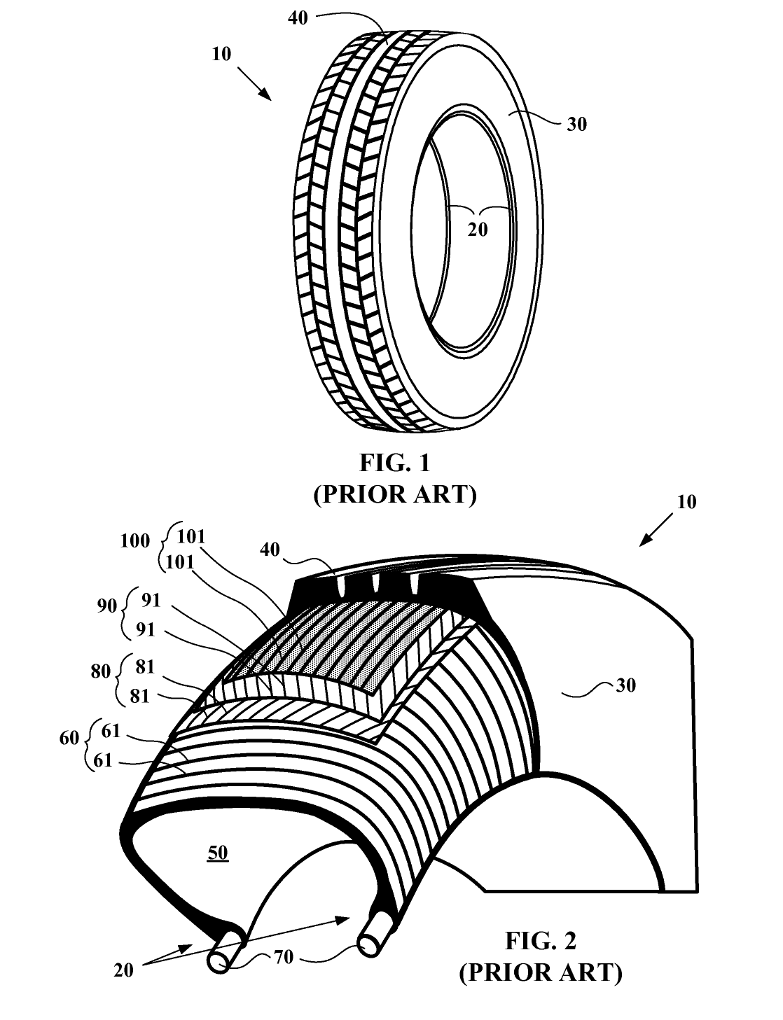

FIG. 1 schematically depicts a tire 10 according to the prior art. The tire 10 comprises a crown comprising a crown reinforcement (not visible in FIG. 1) surmounted by a tread 40, two sidewalls 30 extending the crown radially inwards, and two beads 20 radially inside of the sidewalls 30.

FIG. 2 schematically depicts a partial perspective view of a tire 10 according to the prior art and illustrates the various components of the tire. The tire 10 comprises a carcass reinforcement 60 made up of threads 61 coated with rubber compounds, and two beads 20 each comprising annular reinforcing structures 70 which hold the tire 10 on the rim (not depicted). The carcass reinforcement 60 is anchored in each of the beads 20. The tire 10 further comprises a crown reinforcement comprising two plies 80 and 90. Each of the plies 80 and 90 is reinforced with thread-like reinforcing elements 81 and 91 which are parallel within each layer and cross from one layer to the next, making angles ranging between 10° and 70° with the circumferential direction. The tire further comprises a hooping reinforcement 100, arranged radially on the outside of the crown reinforcement, this hooping reinforcement being formed of circumferentially directed spiral-wound reinforcing elements 101. A tread 40 is laid on the hooping reinforcement; it is this tread 40 that provides contact between the tire 10 and the road surface. The tire 10 depicted is a “tubeless” tire: it comprises an “inner liner” 50 made of a rubber compound impervious to the inflation gas, covering the interior surface of the tire.

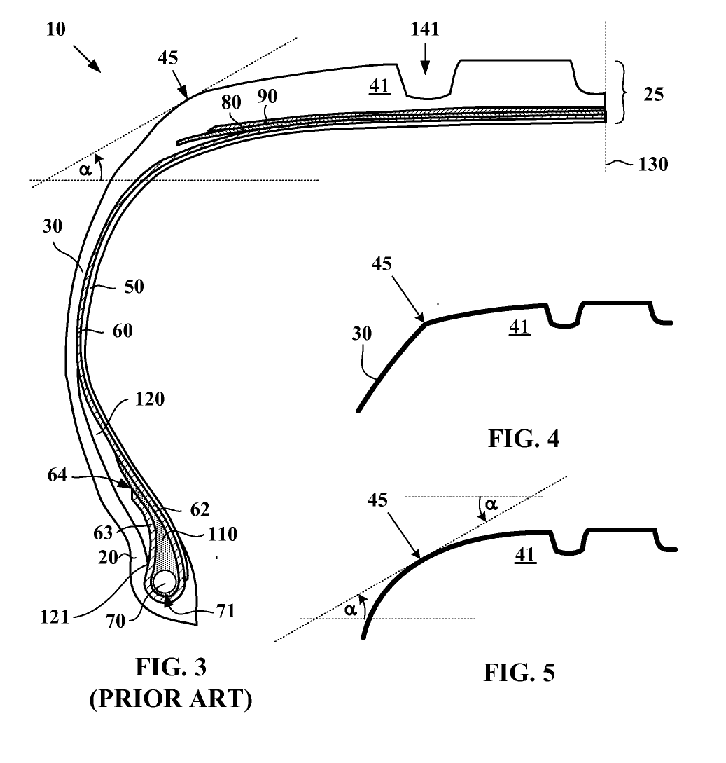

FIG. 3 schematically depicts, in radial cross section, one quarter of a reference tire 10 of the Energy™ Saver type commercialized by Michelin. The tire 10 comprises two beads 20 configured to come into contact with a mounting rim (not depicted), each bead 20 comprising a bead wire 70. Two sidewalls 30 extend the beads 20 radially outwards and meet in a crown 25 comprising a crown reinforcement formed of a first layer of reinforcing elements 80 and of a second layer of reinforcing elements 90, and radially surmounted by a tread. The tread is divided, by the median plane 130 of the tire, into a first semi-tread 41 which extends axially from the median plane 130 of the tire toward a first axial edge 45 of the tread, the first semi-tread comprising a first circumferential groove 141 opening onto the rolling surface, and a second semi-tread (not depicted) that extends axially from said median plane 130 toward a second axial edge of the tread.

The way in which the axial edges of a tread are determined is illustrated in FIGS. 4 and 5 each of which shows the profile of a semi-tread 41 and of that part of the sidewall 30 that is adjacent to it. In some tire designs, the transition from tread to sidewall is abrupt, as in the case depicted in FIG. 4, and determining the axial edge 45 of the semi-tread 41 is obvious. However, there are tire designs in which the transition between tread and sidewall is continuous. An example is given in FIG. 5. The edge of the tread is then determined as follows. The tangent to the rolling surface of the tire at any point on the rolling surface in the region of transition toward the sidewall is drawn onto a radial cross section of the tire. The axial edge is the point at which the angle α (alpha) between said tangent and an axial direction is equal to 30°. When there are several points at which the angle α (alpha) between said tangent and an axial direction is equal to 30°, it is the radially outermost point that is adopted. In the case of the tire depicted in FIG. 3, the axial edge 45 has been determined in this way.

Each layer of reinforcing elements 80 and 90 comprises thread-like reinforcing elements, coated in a matrix formed of rubber compound. The reinforcing elements of each layer are substantially mutually parallel; the reinforcing elements of the two layers cross from one layer to the next at an angle of about 20° to 30°, as is well known to those skilled in the art for tires known as radial tires.

The tire 10 further comprises a carcass reinforcement 60 which extends from the beads 20 through the sidewalls 30 as far as the crown 25. This carcass reinforcement 60 here comprises thread-like reinforcing elements that are directed radially, that is to say that make an angle greater than or equal to 80° and less than or equal to 90° with the circumferential direction.

The carcass reinforcement 60 comprises a plurality of carcass reinforcing elements shown as threads 61 in FIG. 2. The carcass reinforcement is anchored in the two beads 20 by wrapping around the bead wire 70, so as to form, in each bead, a main portion 62 and a wrapped-around portion 63. The wrapped-around portion extends radially to the outside as far as an end 64.

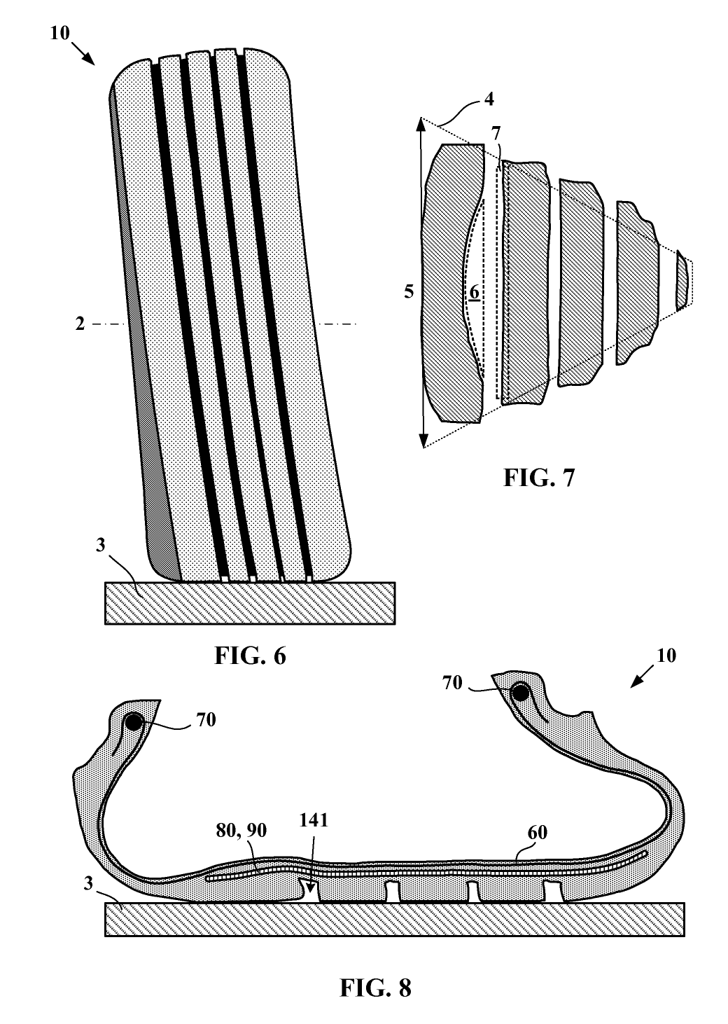

FIGS. 6 to 9 schematically depict the deformation of a tire according to the prior art, inflated to 3 bar and heavily loaded (load of 7100 N) when it experiences substantial transverse loadings (camber: −4.4°, transversal slip rate: 3 m/s). FIG. 6 corresponds to a view in the direction of forward travel of the tire. The reference 2 indicates the axis of rotation of the tire 10 and the reference 3 the ground on which the tire 10 is rolling.

FIG. 7 depicts the footprint of the tire 10 on the ground 3. To a first approximation, this footprint is in the shape of a trapezium 4 the long side 5 of which is on that side of the vehicle on which the tire 10 is mounted that lies on the outside with respect to the center of the bend. As FIG. 7 shows, the footprint of the outermost rib with respect to the center of the bend is reduced. In the region that bears the reference 6, this rib is losing contact with the ground, and this has the effect of increasing the local loading in the region bearing the reference 7, that is to say in the vicinity of the corner edge of the adjacent rib.

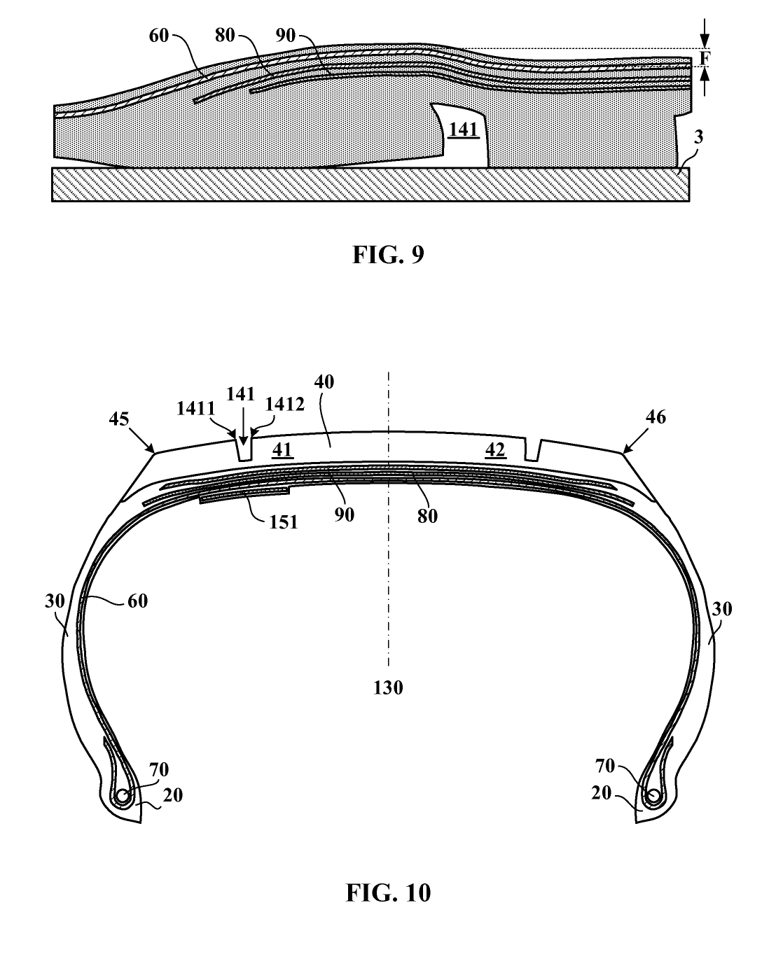

FIG. 8 shows, in radial cross section, that part of the tire 10 that is in contact with the ground 3. FIG. 9 gives a detail of this view. The heavy deformation of the tread in proximity to the groove 141 can be seen, with a distinct loss of contact with the ground in the region axially on the outside of the groove 141. This loss of contact can occur because, in the vicinity of the groove, the crown of the tire is experiencing a great deal of meridian flexing.

Given the magnitude of this flexing and of the deformation of the tread to which it leads, it can be understood that the tread wears unevenly.

The present invention seeks to reduce this uneven wear. The objective is achieved with a tire according to an embodiment of the invention, such as the tire depicted in FIG. 10. This tire has two beads 20 configured to come into contact with a mounting rim (not depicted), each bead comprising a bead wire 70, two sidewalls 30 extending the beads 20 radially outwards, the two sidewalls meeting in a crown comprising a crown reinforcement 80, 90 surmounted by a tread 40 comprising a rolling surface. The tire 10 also comprises a carcass reinforcement 60 extending from the beads 20 through the sidewalls 30 as far as the crown, the carcass reinforcement being anchored in the two beads 20, in this instance by wrapping them around the bead wire 70.

The tread 40 is divided, by the median plane 130 of the tire 10, into a first semi-tread 41 which extends axially from the median plane 130 toward a first axial edge 45 of the tread 40, the first semi-tread 41 comprising a first main circumferential groove 141 opening onto the rolling surface, and a second semi-tread 42 which extends axially from the median plane 130 toward a second axial edge 46 of the tread.

The tire further comprises an additional stiffening reinforcement 151 comprising a plurality of textile or metal thread-like reinforcing elements that are directed “substantially radially”, that is to say which make an angle greater than or equal to 60° (and preferably 80°) and less than or equal to 90° with the circumferential direction. This additional stiffening reinforcement 151 lies radially on the inside of the carcass reinforcement 60 and in direct radial alignment with the first main circumferential groove 141.

In a tire according to an embodiment of the invention, the axial width of the additional stiffening reinforcement 151 is carefully limited. It extends both axially outside of the axially outermost point 1411 of the first main circumferential groove 141 and axially on the inside of the axially innermost point 1412 of the first main circumferential groove 141. The precise criteria are illustrated in FIGS. 11 to 16.

FIG. 11 depicts, in radial cross section, one portion of a tire 10 according to an embodiment of the invention. In this particular instance, the tread comprises one single first main circumferential groove 141. The additional stiffening reinforcement 151 which lies in direct radial alignment with this groove extends axially on the outside of the axially outermost point 1411 of the first main circumferential groove 141, such that, in any radial cross section, the axial distance DEE1 between the axially outermost point 1511 of the additional stiffening reinforcement 151 and the axially outermost point 1411 of the first main circumferential groove 141 is less than or equal to 75% of the axial distance DAE1. Because there is no circumferential groove opening onto the rolling surface axially between the first main circumferential groove 141 and the first axial edge 45 of the tread 40, this axial distance DAE1 is defined as being the axial distance between the axially outermost point 1411 of the first main circumferential groove 141 and the first axial edge 45 of the tread 40. In this particular instance, DEE1=0.1·DAE1.

Furthermore, the additional stiffening reinforcement 151 extends axially on the inside of the axially innermost point 1412 of the first main circumferential groove 141, such that, in any radial cross section, the axial distance DEI1 between the axially innermost point 1512 of the additional stiffening reinforcement 151 and the axially innermost point 1412 of said first main circumferential groove 141 is less than or equal to 75% of the axial distance DAI1. Because there is no circumferential groove opening onto the rolling surface axially between the first main circumferential groove 141 and the second axial edge 46 of the tread 40, this axial distance DAI1 is defined as being the axial distance between the axially innermost point 1412 of said first main circumferential groove 141 and the second axial edge 46 of the tread 40. In this particular instance, DEI1=0.06·DAI1.

When there is a circumferential groove opening onto the rolling surface axially between the first main circumferential groove 141 and at least one of the axial edges 45, 46 of the tread 40, the definition of the distances DAE1 or DAI1 is different, as explained below.

FIG. 12 shows the case where there is an additional circumferential groove 161 opening onto the rolling surface between the first main circumferential groove 141 and the second axial edge 46 of the tread 40. The axial distance DAI1 is then defined as the axial distance between the axially innermost point 1412 of the first main circumferential groove 141, and that point 1611 of said additional circumferential groove 161 that is axially closest to said first main circumferential groove 141. In this particular instance, DEI1=0.13·DAI1. The definition of DAE1 is unchanged by comparison with the situation depicted in FIG. 11.

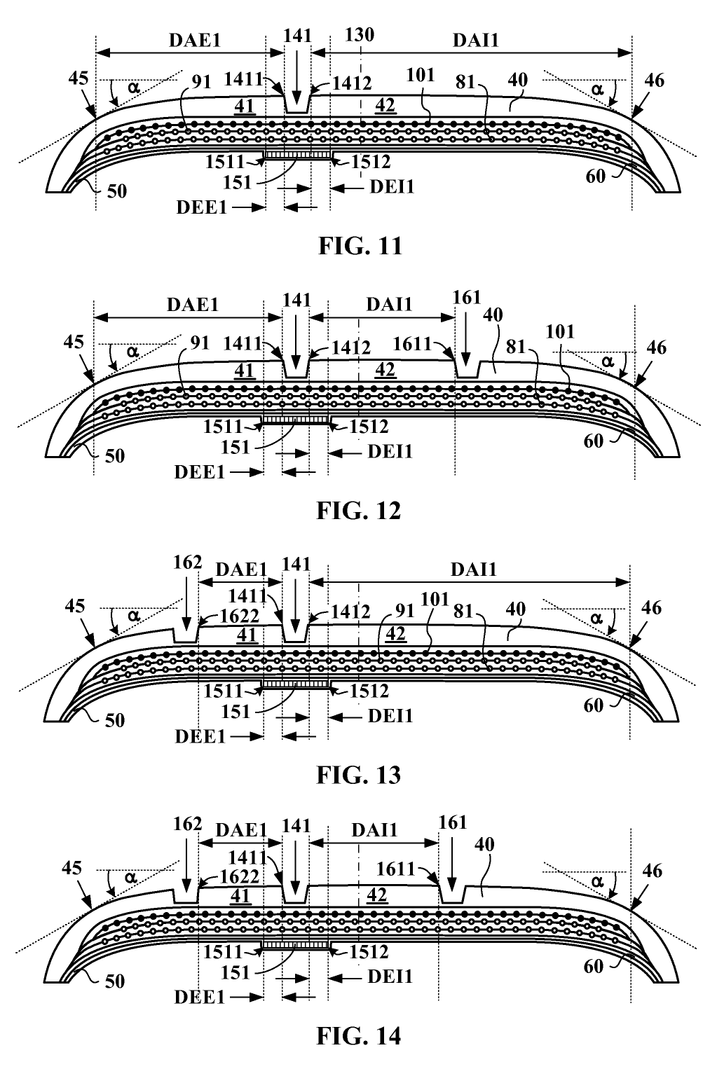

FIG. 13 shows the case where there is an additional circumferential groove 162 opening onto the rolling surface between the first main circumferential groove 141 and the first axial edge 45 of the tread 40. The axial distance DAE1 is then defined as the axial distance between the axially outermost point 1411 of the first main circumferential groove 141 and the axially innermost point 1622 of said additional circumferential groove 162. In this particular instance, DEE1=0.29·DAE1. The definition of DAI1 is unchanged by comparison with the situation depicted in FIG. 11.

In general, in this configuration, it is preferable for the distance DEE1 to be less than or equal to 50% of the axial distance between the axially outermost point 1411 of said first main circumferential groove 141 and the axially innermost point 1622 of said additional circumferential groove 162.

Naturally, there may be instances where additional circumferential grooves open onto the rolling surface axially on each side of the first main circumferential groove. Such a situation is depicted in FIG. 14. The definition of DAI1 is then again as discussed in respect of FIG. 12 and the definition of DAE1 is again as discussed in respect of FIG. 13.

Of course, when there are several additional circumferential grooves on one side and/or the other side of the first main circumferential groove, then it is the axially closest additional circumferential groove that is taken into consideration when determining the distances DAE1 and DAI1.

All of the tires depicted in FIGS. 10 to 14 have just one additional stiffening reinforcement. Of course, the additional stiffening reinforcement will only play its part correctly if it is positioned on that side of the tire which, when the tire is mounted on the vehicle in said predetermined direction of mounting, faces the outside of the vehicle. The configuration with one single additional stiffening reinforcement is therefore particularly well suited to so-called “asymmetric” tires which have a predetermined direction of mounting so that one sidewall of the tire is always on the outside of the vehicle. These tires are generally marked (with “outside” or “inside”) to indicate to the user which sidewall of the tire is to face toward the outside of the vehicle and which side is to face toward the vehicle.

There are also tires which do not have such a predetermined direction of mounting either because they are quite simply symmetric or because they are “directional”. What is meant here by a tire that is said to be “directional” is that it has a preferred direction of rotation. Such a tire will be mounted on the vehicle in such a way that its preferred direction of rotation corresponds to the direction of rotation of the tire as the vehicle moves forward.

Because such tires do not have any marking indicating that the marked sidewall has to face toward the vehicle (or, as appropriate, has to face toward the outside of the vehicle) it is therefore necessary to provide additional stiffening reinforcements on each side of the median plane of the tire, particularly in order to obtain the expected effects of the stiffening reinforcement on the integrity of the tread in a bend on each external edge.

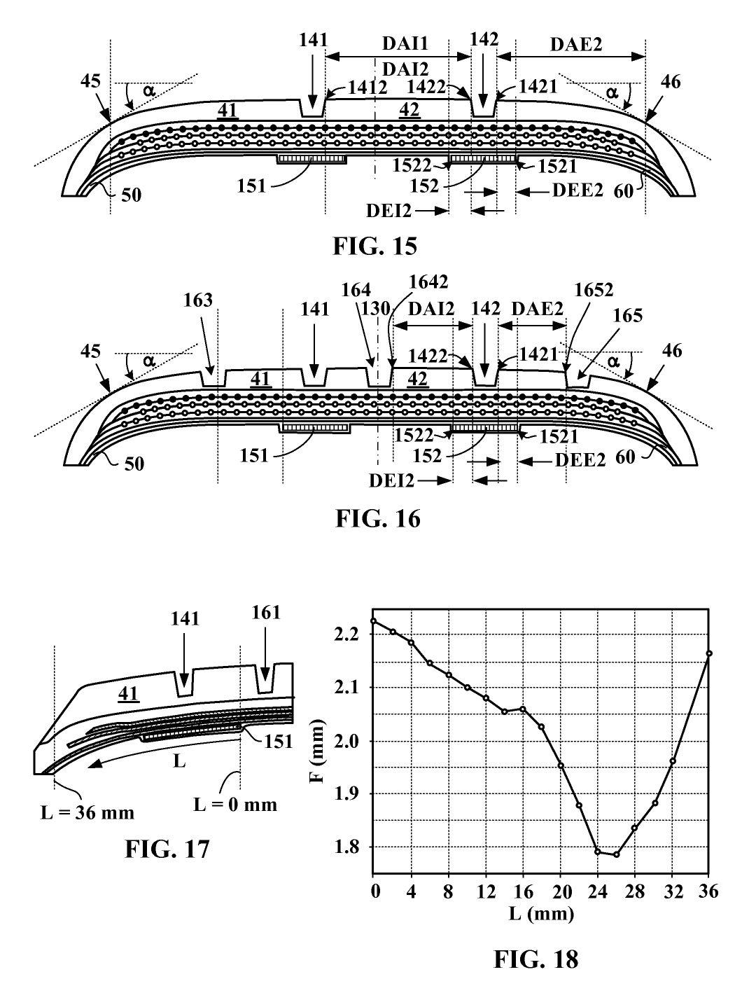

FIG. 15 depicts, in radial cross section, a portion of such a tire. The second semi-tread 42 comprises a second main circumferential groove 142 opening onto the rolling surface and the tire comprises a second additional stiffening reinforcement 152 comprising a plurality of substantially radially directed thread-like reinforcing elements. This second additional stiffening reinforcement 152 lies radially on the inside of the carcass reinforcement 60 and in direct radial alignment with the second main circumferential groove 142. The second additional stiffening reinforcement 152 extends axially on the outside of the axially outermost point 1421 of said second main circumferential groove 142, such that the axial distance DEE2 between the axially outermost point 1521 of the second additional stiffening reinforcement 152 and the axially outermost point 1421 of said second main circumferential groove 142 is less than or equal to 75% of the axial distance DAE2. Because there is no circumferential groove axially between the second main circumferential groove 142 and the second axial edge 46 of the tread 40, the axial distance DAE2 is defined as being the axial distance between the axially outermost point 1421 of the second main circumferential groove 142 and the second axial edge 46 of the tread.

The second additional stiffening reinforcement 152 extends axially inside the axially innermost point 1422 of the second main circumferential groove 142, such that the axial distance DEI2 between the axially innermost point 1522 of the second additional stiffening reinforcement 152 and the axially innermost point 1422 of said second main circumferential groove 142 is less than or equal to 75% of the axial distance DAI2. Because there is no circumferential groove axially between the second main circumferential groove 142 and the first main circumferential groove 141, the axial distance DAI2 is defined as being the axial distance between the axially innermost point 1422 of the second main circumferential groove 142 and the axially innermost point 1412 of the first main circumferential groove 141. In this particular case DAI1=DAI2.

Naturally, there may be instances where additional circumferential grooves open onto the rolling surface axially on each side of the first and/or of the second main circumferential groove. A situation such as this is depicted in FIG. 16 where the tread comprises three additional circumferential grooves 163 to 165. The definitions of the distances DAI2 and DAE2 therefore change. DAE2 corresponds to the axial distance between the axially outermost point 1421 of said second main circumferential groove 142 and the axially innermost point 1652 of said additional circumferential groove 165 axially between the second main circumferential groove 142 and the second axial edge 46 of the tread. As for the distance DAI2, this is defined as being the axial distance between the axially innermost point 1422 of said second main circumferential groove 142 and that point 1642 of the additional circumferential groove 164 (axially between the second main circumferential groove 142 and the first main circumferential groove 141) that is axially closest to said second main circumferential groove 142.

When the tread 40 is provided with an additional circumferential groove 165 axially between the second main circumferential groove 142 and the second axial edge 46 of the tread 40, the axial distance DEE2 between the axially outermost point 1521 of the second additional stiffening reinforcement 152 and the axially outermost point 1421 of said second main circumferential groove 142 is less than or equal to 50% of the distance DAE2 as defined in the previous paragraph.

FIGS. 17 and 18 illustrate how important it is to choose the axial width of the additional stiffening reinforcement with care. The graph of FIG. 18 shows the deflection F of the crown block of a tire, part of which is depicted in FIG. 17, as a function of the axial width L of the additional stiffening reinforcement. The deflection F is indicated in FIG. 9. It characterizes the tilting of the crown block and, as a result, the degradation of the adjacent portions. The optimal width is the width at which the deflection is at a minimum, in this instance 24 to 26 mm. When the width is increased beyond this optimum value, the situation deteriorates again. By increasing the length of the additional stiffening reinforcement to 36 mm, it becomes entirely ineffective.

Rolling tests on 205/55 R 16 tires (running conditions corresponding to BMW's “Nürburgring endurance” acceptance tests, well-known to those skilled in the art, involving 20 laps of the old 20 km track in sporty driving) have revealed a very marked reduction in uneven wear by comparison with a tire that has no stiffening reinforcements.

1. A tire configured to be mounted on a mounting rim of a wheel of a vehicle, comprising:
two beads configured to come into contact with the mounting rim, each bead comprising at least one annular reinforcing structure;
two sidewalls extending the beads radially outward, the two sidewalls meeting in a crown comprising a crown reinforcement surmounted by a tread comprising a rolling surface;
at least one carcass reinforcement extending from the beads through the sidewalls as far as the crown, the carcass reinforcement being anchored in the two beads;
wherein the tread is divided, by a median plane of the tire, into:
a first semi-tread which extends axially from said median plane toward a first axial edge of the tread, the first semi-tread comprising a first main circumferential groove opening onto the rolling surface, and
a second semi-tread which extends axially from said median plane toward a second axial edge of the tread,
the tire further comprising an additional stiffening reinforcement comprising a plurality of substantially radially directed thread-like reinforcing elements, this additional stiffening reinforcement being situated radially on the inside of the carcass reinforcement and in direct radial alignment with said first main circumferential groove, the additional stiffening reinforcement extending axially on the outside of the axially outermost point of said first main circumferential groove, such that, in any radial cross section, the axial distance DEE1 between the axially outermost point of the additional stiffening reinforcement and the axially outermost point of said first main circumferential groove is less than or equal to 75% of an axial distance DAE1, this axial distance DAE1 being defined:
either, if there is no circumferential groove opening onto the rolling surface axially between said first main circumferential groove and said first axial edge of the tread, as the axial distance between the axially outermost point of said first main circumferential groove and said first axial edge of the tread,
or, if there is an additional circumferential groove opening onto the rolling surface axially between said first main circumferential groove and said first axial edge of the tread, as the axial distance between the axially outermost point of said first main circumferential groove and the axially innermost point of said additional circumferential groove, the additional stiffening reinforcement extending axially on the inside of the axially innermost point of said first main circumferential groove, such that, in any radial cross section, the axial distance DEI1 between the axially innermost point of the additional stiffening reinforcement and the axially innermost point of said first main circumferential groove is less than or equal to 75% of an axial distance DAI1, this axial distance DAI1 being defined:
either, if there is no circumferential groove opening onto the rolling surface axially between said main circumferential groove and said second axial edge of the tread, as the axial distance between the axially innermost point of said first main circumferential groove and said second axial edge of the tread,
or, if there is an additional circumferential groove opening onto the rolling surface axially between said first main circumferential groove and said second axial edge of the tread, as the axial distance between the axially innermost point of said first main circumferential groove and the point of said additional circumferential groove that is axially closest to said first main circumferential groove.

2. The tire of claim 1, wherein the carcass reinforcement comprises a plurality of carcass reinforcing elements and wherein the carcass reinforcing elements are textile.

3. The tire of claim 1, wherein the thread-like reinforcing elements of the additional stiffening reinforcement are made of metal.

4. The tire of claim 1, wherein the thread-like reinforcing elements of the additional stiffening reinforcement are textile.

5. The tire of claim 1, wherein the tread has no additional circumferential groove opening onto the rolling surface axially between said first main circumferential groove and said first axial edge of the tread.

6. The tire of claim 1, wherein the tread does have an additional circumferential groove opening onto the rolling surface axially between said first main circumferential groove and said first axial edge of the tread, and
wherein the axial distance DEE1 between the axially outermost point of the additional stiffening reinforcement and the axially outermost point of said first main circumferential groove is less than or equal to 50% of the axial distance DAE1 between the axially outermost point of said first main circumferential groove and the axially innermost point of said additional circumferential groove.

7. The tire of claim 1, wherein the tire has a predetermined direction of mounting, such that the first axial edge of the tread lies on that side of the tire which, when the tire is mounted on the vehicle in said predetermined direction of mounting, faces the outside of the vehicle, the tire being provided with one single additional stiffening reinforcement.

8. The tire of claim 1, wherein the tire has a preferred direction of rotation, and
wherein said second semi-tread has a second main circumferential groove opening onto the rolling surface, the tire further comprising a second additional stiffening reinforcement comprising a plurality of substantially radially directed thread-like reinforcing elements, this second additional stiffening reinforcement being situated radially on the inside of the carcass reinforcement and in direct radial alignment with said second main circumferential groove,
the second additional stiffening reinforcement extending axially on the outside of the axially outermost point of said second main circumferential groove, such that, in any radial cross section, the axial distance DEE2 between the axially outermost point of the second additional stiffening reinforcement and the axially outermost point of said second main circumferential groove is less than or equal to 75% of the axial distance DAE2, this axial distance DAE2 being defined:
either, if there is no circumferential groove axially between said second main circumferential groove and said second axial edge of the tread, as the axial distance between the axially outermost point of said second main circumferential groove and said second axial edge of the tread,
or, if there is an additional circumferential groove axially between said second main circumferential groove and said second axial edge of the tread, as the axial distance between the axially outermost point of said second main circumferential groove and the axially innermost point of said additional circumferential groove,
the second additional stiffening reinforcement extending axially on the inside of the axially innermost point of said second main circumferential groove, such that, in any radial cross section, the axial distance DEI2 between the axially innermost point of the second additional stiffening reinforcement and the axially innermost point of said second main circumferential groove is less than or equal to 75% of the axial distance DAI2, this axial distance DAI2 being defined:
either, if there is no circumferential groove axially between said second main circumferential groove and said first main circumferential groove, as the axial distance between the axially innermost point of said second main circumferential groove and the axially innermost point of said first main circumferential groove,
or, if there is an additional circumferential groove axially between said second main circumferential groove and said first main circumferential groove, as the axial distance between the axially innermost point of said second main circumferential groove and that point of this additional circumferential groove that is axially closest to said second main circumferential groove.

9. The tire of claim 8, wherein the tread is provided with an additional circumferential groove axially between said second main circumferential groove and said second axial edge of the tread, and
wherein the axial distance DEE2 between the axially outermost point of the second additional stiffening reinforcement and the axially outermost point of said second main circumferential groove is less than or equal to 50% of the axial distance DAE2 between the axially outermost point of said second main circumferential groove and the axially innermost point of said additional circumferential groove.
